(19) United States
(12) Patent Application Publication
(10) Pub. No.: US 2001/0046881 A1
(43) Pub. Date: Nov. 29, 2001

(54) Radio frequency receiver in a mobile telephone

(75) Inventor: Won-Kyung Kim, Seoul (KR)

Correspondence Address: Paul J. Farrell, DILWORTH & BARRESE, LLP, 333 Earle Ovington Blvd., Uniondale, NY, 11553, US

(73) Assignee: Samsung Electronics Co., Ltd.

(21) Appl. No.: 09/841,681

(22) Filed: Apr. 24, 2001

(30) Foreign Application Priority Data
May 23, 2000 (KR) 2000-27795

(51) Int. Cl. H04M 1/00

(52) U.S. Cl. 455/553; 455/168.1; 455/180.1

(57) ABSTRACT

Disclosed is an RF receiver for receiving an RF signal of a prescribed reception band and converting the received RF signal to an IF signal of a selected reception channel in a mobile telephone. The RF receiver comprises first and second band division filters for band-pass filtering an RF signal of a first reception band and an RF signal of a second reception band, respectively, the first and second reception bands being determined by equally dividing the reception band; a first RF switch for selectively applying the received RF signal to one of the first and second band division filters; a second RF switch for selecting one of two output signals from the first and second band division filters; a mixer for converting the signal selected by the second RF switch to an IF signal; and a controlling unit for controlling the first and second RF switches such that the first and second RF switches should be connected to one of the first and second band division filters, a frequency band of which corresponds to a frequency band to which the selected reception channel belongs.

### PRIORITY

This application claims priority to an application entitled “Radio Frequency Receiver in a Mobile Telephone” filed in the Korean Industrial Property Office on May 23, 2000 and assigned Serial No. 2000-27795, the contents of which are hereby incorporated by reference.

### BACKGROUND OF THE INVENTION

1. Field of the Invention

The present invention relates generally to a mobile telephone, and in particular, to a radio frequency (RF) receiver for receiving an RF signal of a prescribed reception band and converting the received RF signal to an intermediate frequency (IF) signal of a reception channel.

2. Description of the Related Art

In general, a mobile telephone has an RF receiver shown in FIG. 1. Referring to FIG. 1, a duplexer 102 separates transmission signals from signals received through an antenna 100. That is, the duplexer 102 transmits to the antenna 100 an RF transmission signal inputted from an RF transmitter (not shown) of the mobile telephone, and outputs to a low-noise amplifier (LNA) 104 an RF signal received through the antenna 100. The received RF signal is low-noise amplified by the LNA 104 and then band-pass filtered by a full-band filter 106. Here, the full-band filter 106 band-pass filters the amplified RF signal over the whole prescribed reception band. For example, in an American style PCS (Personal Communications Service) mobile telephone according to the J-STD-018 standard, a transmission band and a reception band each have a bandwidth of 60 MHz. The transmission band has a frequency of 1850 to 1910 MHz, and the reception band has a frequency of 1930 to 1990 MHz. A mixer 108 mixes the band-pass filtered RF signal with a local oscillation frequency signal for a presently selected reception channel, to convert the RF signal to an IF signal. The IF signal is filtered by an IF filter 110 and then outputted to a base band processing unit (not shown). In this manner, the RF receiver shown in FIG. 1 receives an RF signal of a prescribed reception band and converts the RF signal into an IF signal of a reception channel.

Meanwhile, since the full-band filter 106 band-pass filters a received RF signal over the whole reception band, it should be designed and made in consideration of both a transmission power rejection characteristic and a reception insertion loss. Therefore, the full-band filter 106 has a poor transmission power rejection characteristic and a poor reception insertion loss characteristic. FIG. 2 illustrates a frequency-to-insertion loss characteristic of the full-band filter 106.

As shown in FIG. 2, the reception band has an uneven insertion loss characteristic, so that the reception channels have different reception sensitivities. In addition, the conventional RF receiver has a poor transmission power rejection characteristic, so that the transmission power is insufficiently rejected causing an increase in cross-modulation between the transmission power and a jamming signal. The increase in cross-modulation results in deterioration of a single tone desensitization performance. Furthermore, a narrow gap of 20 MHz between the highest frequency 1910 MHz of the transmission band and the lowest frequency 1930 MHz of the reception band may raise an interference problem.

### SUMMARY OF THE INVENTION

It is, therefore, an object of the present invention to provide an RF receiver capable of decreasing an insertion loss of a reception band and improving a transmission power rejection characteristic in a mobile telephone.

To achieve the above and other objects, there is provided an RF receiver for receiving an RF signal of a prescribed reception band and converting the received RF signal to an IF signal of a selected reception channel in a mobile telephone. The RF receiver comprises first and second band division filters for band-pass filtering an RF signal of a first reception band and an RF signal of a second reception band, respectively, the first and second reception bands being determined by equally dividing the reception band; a first RF switch for selectively applying the received RF signal to one of the first and second band division filters; a second RF switch for selecting one of two output signals from the first and second band division filters; a mixer for converting the signal selected by the second RF switch to an IF signal; and a controlling unit for controlling the first and second RF switches such that the first and second RF switches are connected to one of the first and second band division filters, a frequency band of which corresponds to a frequency band to which the selected reception channel belongs.

Preferably, the first and second reception bands are lower and upper frequency bands, respectively.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating an RF receiver of a conventional mobile telephone;

FIG. 2 is a characteristic diagram of the full-band filter shown in FIG. 1;

FIG. 3 is a block diagram illustrating an RF receiver of a mobile telephone according to an embodiment of the present invention; and

FIGS. 4A and 4B are characteristic diagrams of the first and second band division filters shown in FIG. 3, respectively.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

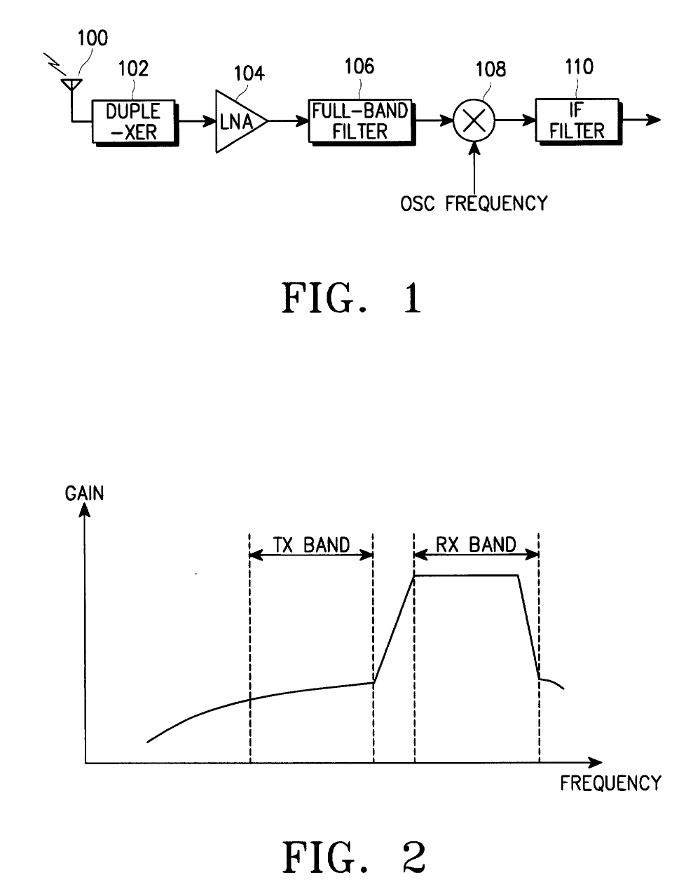

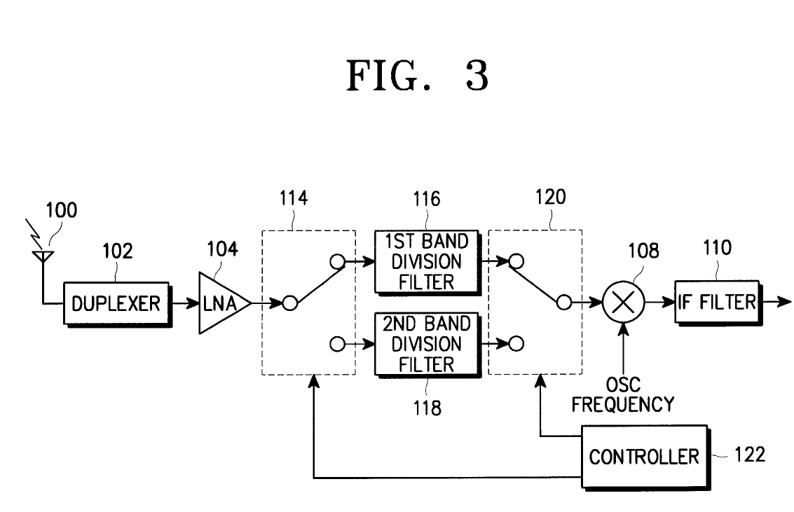

FIG. 3 shows a block diagram of an RF receiver in a mobile telephone according to an embodiment of the present invention. Referring to FIG. 3, the RF receiver according to the present invention has first and second band division filters 116 and 118, instead of the full-band filter 106 used in the conventional RF receiver shown in FIG. 1. Accordingly, the RF receiver of the present invention further includes first and second RF switches 114 and 120, and a controlling unit 122 for switching the first and second RF switches 114 and 120 to either the first band division filter 116 or the second band division filter 118.

The first and second band division filters 116 and 118 band-pass filter an RF input signal of a first reception band and an RF input signal of a second reception band, respectively. The first and second reception bands are determined by equally dividing the reception band into a lower frequency band and a higher frequency band. For example, in the PCS mobile telephone, the first reception band has a frequency of 1930 to 1960 MHz and the second reception band has a frequency of 1961 to 1990 MHz.

Input terminals of the first and second band division filters 116 and 118 are selectively connected to an output terminal of the low noise amplifier (LNA) 104 through the first RF switch 114. Output terminals of the first and second band division filters 116 and 118 are selectively connected to an input terminal of the mixer 108 through the second RF switch 120.

The first and second RF switches 114 and 120 are interlockingly switched under the control of the controlling unit 122. The first RF switch 114 selectively applies an RF input signal outputted from the LNA 104 to one of the first and second band division filters 116 and 118. The second RF switch 120 selects one of two signals outputted from the first and second band division filters 116 and 118, and outputs the selected signal to the mixer 108, which converts the selected RF signal to an IF signal.

For the controlling unit 122, a microprocessor unit (MPU) is typically used which manages a voice communication function, a data communication function, and other functions of the mobile telephone. In particular, the MPU has a program for controlling the first and second RF switches 114 and 120 such that they are selectively switched to one of the first and second band division filters 116 and 118, a frequency band of which corresponds to a frequency band to which the selected reception channel belongs.

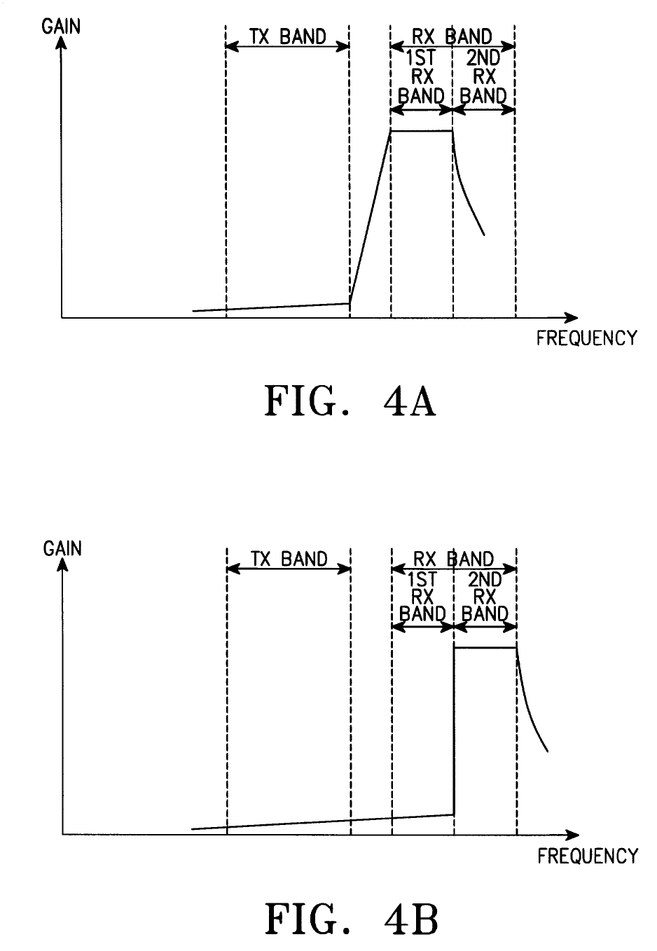

For example, if the reception channel belongs to the first reception band, the controlling unit 122 switches the first and second RF switches 114 and 120 to the first band division filter 116. Then, an RF signal received over an antenna 100 is inputted to the mixer 108 through the duplexer 102, the LNA 104, the first RF switch 114, the first band division filter 116 and the second RF switch 120. Consequently, the received RF signal is band-pass filtered over the first reception band of 1930 to 1960 MHz. FIG. 4A shows a frequency-to-insertion loss characteristic of the RF receiver when the first band division filter 116 is selected.

Otherwise, if the reception channel belongs to the second reception band, the controlling unit 122 switches the first and second RF switches 114 and 120 to the second band division filter 118. Then, the RF signal received over the antenna 100 is inputted to the mixer 108 through the duplexer 102, the LNA 104, the first RF switch 114, the second band division filter 118 and the second RF switch 120. Consequently, the received RF signal is band-pass filtered over the second reception band of 1961 to 1990 MHz. FIG. 4B shows a frequency-to-insertion loss characteristic of the RF receiver when the second band division filter 118 is selected.

As shown in FIGS. 4A and 4B, the reception band is equally divided into the first and second reception bands and thus, a gap between the second reception band and the transmission band becomes 50 MHz, thereby making it possible to decrease the insertion loss of the reception band when designing the filters. The decrease in insertion loss of the reception band will contribute to an improvement of the reception sensitivity. In addition, the transmission power rejection characteristic is also improved, so that the cross-modulation with the jamming signal is decreased improving the single tone desensitization performance, thereby facilitating designing of the filters.

As described above, the RF receiver according to the present invention has two band division filters for band-pass filtering the received RF signal over the two divided reception bands, respectively, thereby making it possible to decrease an insertion loss of the reception band and improve the transmission power rejection characteristic.

While the invention has been shown and described with reference to a certain preferred embodiment thereof, it will be understood by those skilled in the art that various changes in form and detail may be made therein without departing from the spirit and scope of the invention as defined by the appended claims. For example, although the reception band is equally divided into the first and second reception bands in the embodiment of the present invention, the reception band can also be differently divided, if necessary.

What is claimed is:

1. A radio frequency (RF) receiver for receiving an RF signal of a prescribed reception band and converting the received RF signal to an intermediate frequency (IF) signal of a selected reception channel in a mobile telephone, the RF receiver comprising:
first and second band division filters for band-pass filtering an RF signal of a first reception band and an RF signal of a second reception band, respectively;
a first RF switch for selectively applying the received RF signal to one of the first and second band division filters;
a second RF switch for selecting one of two output signals from the first and second band division filters; a
a mixer for converting the signal selected by the second RF switch to an IF signal; and
a controlling unit for controlling the first and second RF switches such that the first and second RF switches are connected to one of the first and second band division filters, a frequency band of which corresponds to a frequency band to which the selected reception channel belongs.

2. The RF receiver as claimed in claim 1, wherein the first and second reception bands are lower and upper frequency bands, respectively, which are determined by equally dividing the prescribed reception band.
